(19) United States
(12) Patent Application Publication
(10) Pub. No.: US 2001/0020969 A1
(43) Pub. Date: Sep. 13, 2001

(54) Flash-over detector

(76) Inventor: Christopher Hall, Cambridgeshire (GB)

Correspondence Address: Lee, Mann, Smith, McWilliams, Sweeney & Ohlson, P. O. Box 2786, Chicago, IL, 60690-2786, US

(21) Appl. No.: 09/782,213

(22) Filed: Feb. 13, 2001

(30) Foreign Application Priority Data
Mar. 3, 2000 (EP) 00301754.8

(51) Int. Cl. B41J 2/02

(52) U.S. Cl. 347/73

(57) ABSTRACT

A flash-over detector for a continuous ink jet printer, the printer including a positive deflector plate having a positive supply conductor; a negative deflector plate having a negative supply conductor, the positive and negative conductors being capacitively coupled with each other; and a ground; the flash-over detector comprising: a sensing element, coupled to one of the conductors, for detecting a flash-over between either of the conductors and either the ground or the other conductor.

This invention relates to a detector for use in a continuous ink jet printer and, in particular, to a flash-over detector for detecting a collapse in the droplet deflection field between the deflection electrodes by providing positive plate to ground, negative plate to ground and plate to plate flash-over detection.

In conventional print heads for use in continuous ink jet printers, a typical trip sensor assembly is designed specifically for each situation in which it is used. These sensors are usually required to have specific insulating properties and have a high dielectric strength. These features are needed so that the sensor is able to withstand the high voltages which are used within the print head. The entire sensor assembly is usually then encapsulated in epoxy to provide environmental protection. Thus, the construction of known sensors of this type is complex and expensive to manufacture.

Collapse in the ink drop deflection field in continuous ink jet printers can often be caused by poor print head set up. Alternatively, poor print quality, due to other factors, leads to stray ink droplets being attracted to the deflection plates which in turn can cause collapse in the deflection field.

The present invention aims to provide a flash over detector which detects a collapse in the ink drop deflection field and which is simple and cheap to manufacture.

According to the present invention, there is provided a flash-over detector for a continuous ink jet printer, the printer including a positive deflector plate having a positive supply conductor; a negative deflector plate having a negative supply conductor, the positive and negative conductors being capacitively coupled with each other; and a ground;

the flash-over detector comprising:

a sensing element, coupled to one of the conductors, for detecting a flash-over between either of the conductors and either the ground or the other conductor.

Preferably, the detector further comprises current limiting means which may be resistor elements. The sensor is designed to be used with standard off the shelf components.

The flash-over detector may be provided with system electronics for controlling the flash over detector. The electronics preferably comprises one or more of the following components: a signal filter; a positive/negative pulse detector; a time domain repetition qualifier; a hardware latch; and a high voltage supply.

The sensing element may be a brass tube which is preferably connected to the system electronics via a sensing conductor. Preferably, the required coupling capacitance between the wire inner and the brass sensing tube is approximately 2 pF for correct operation within the system of the present invention.

Preferably, the negative and positive wires are heat-shrunk together within the print head to provide capacitive coupling therebetween. The capacitive coupling allows sensing to be carried out on only one of the two conductors which thus further reduces design complexity.

Preferably, one of the wires is electrically coupled to the brass tube, preferably by soldering.

Thus, a flash-over between the positive plate and ground will cause a negative going transient in the positive conductor, nominally a red wire. If this conductor is coupled to the brass sensing tube, the transient can be detected by the system electronics. Alternatively, a flash-over between the negative plate and the ground will create a positive going transient in the negative conductor. If the negative conductor is capacitively coupled to the positive conductor, a positive going transient will therefore occur in the positive conductor and as this is coupled to the brass tube, the positive going transient can then be detected by the system electronics.

One embodiment of the present invention will now be described with reference to the accompanying drawings in which:

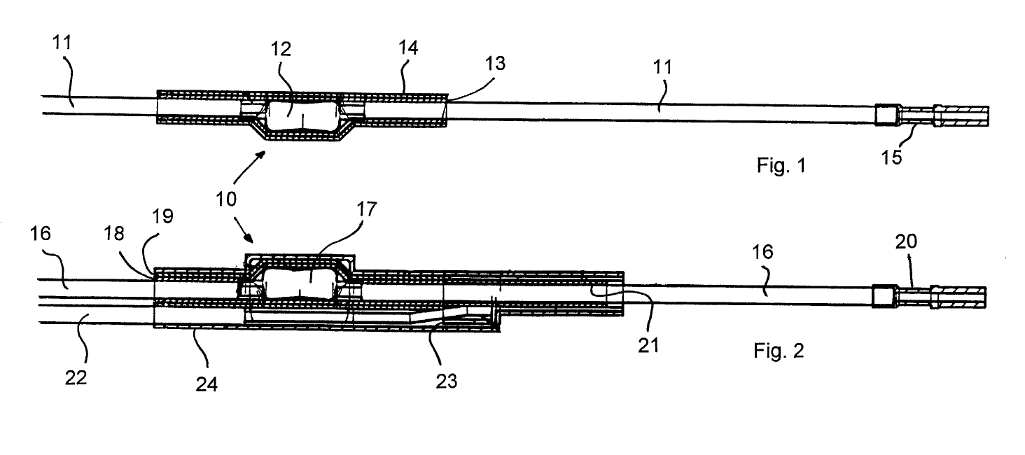

FIG. 1 is a partial cross section through a first part of a detector according to the present invention; and

FIG. 2 is a partial cross section through a second part of a detector according to the present invention.

As can be seen from FIG. 1, a first part of a flash over detector 10 comprises a negative wire 11 which is soldered to a resistor 12. Two insulating heat-shrink sleeves 13, 14 are provided over the connections between the resistor 12 and the negative wire 11. One end of the negative wire 11 has a terminal 15 crimped thereto for connection to a negative deflector plate (not shown). However, it is envisaged that each end of the wire 11 may be fitted with terminals.

From FIG. 2, it can be seen that a second part of a detector 10 comprises a positive wire 16 which is soldered to another resistor 17 and is sealed by insulating heat-shrink sleeves 18, 19. A terminal 20 is provided at one end of the positive wire for connection to a positive deflector plate (not shown). A brass tube 21 is provided over the positive wire 11 such that it abuts with one end of the sleeve 18. A sensing wire 22 is soldered to the exposed part of the brass tube 21. The brass tube 21 is then covered by a third sleeve 23 which extends at least two millimeters beyond the end of the brass tube which is not abutting the sleeve 18.

Finally, the whole assembly is sealed by an outer sleeve 24 to provide a completely sealed unit. The outer sleeve 24 should also extend at least two millimetres beyond the end of the brass tube 21. The positive 16 and negative 11 wires are then heat-shrunk together to provided the necessary capacitive coupling.

It is a possibility that the positive and the negative wires could swop such that the negative wire is coupled with the sensing conductor.

The formula for calculating the coupling capacitance is as follows:

$$\frac{24.2 \times {10}^{- 12} Er}{log ( \frac{b}{a} )}$$

where Er=2.1 (PTFE wire insulating material), b=radius of brass tube and a=radius of wire conductor.

The system electronics, which are not shown, first filter the signal to improve overall noise immunity. The filtered signal is then fed into a positive/negative pulse detector and converted into a digital pulse for further processing. The digital pulse is fed into a time domain pulse repetition qualifier which simply checks that at least two pulses are received within a two second time period. If two or more pulses are received, thus constituting a valid flash-over detection, a hardware latch is cleared which in turn disables the high voltage supply to the print head deflection plates. The latch can only be set or reset by software. If a fault occurs under normal operating conditions, the machine operator will need to acknowledge the fault, preferably by physically operating a switch, before the high voltage supply can be returned to its active state. If this fails to rectify the problem, the operator will then have to inspect and clean the deflection plates manually.

1. A flash-over detector for a continuous ink jet printer, the printer including a positive deflector plate having a positive supply conductor; a negative deflector plate having a negative supply conductor, the positive and negative conductors being capacitively coupled with each other; and a ground;
the flash-over detector comprising:
a sensing element, coupled to one of the conductors, for detecting a flash-over between either of the conductors and either the ground or the other conductor.

2. A detector according to claim 1, wherein the sensing element is a brass tube.

3. A detector according to either claim 1 or claim 2, wherein the negative and positive supply rails are heat-shrunk together.

4. A detector according to any one of claims 1 to 3, further comprising system electronics connected to the sensing element by a sensing conductor.

5. A detector according to claim 4, wherein the system electronics comprises one or more of a signal filter, a positive/negative pulse detector, a time domain repetition qualifier, a hardware latch, and a high voltage supply.

6. A detector according to any one of the preceding claims, wherein at least one end of either the positive or negative supply rails is provided with a terminal.
